(19) United States
(12) Patent Application Publication
(10) Pub. No.: US 2026/0247344 A1
(43) Pub. Date: Aug. 20, 2026

(54) METHODS AND APPARATUSES FOR PAGING

(71) Applicant: NOKIA TECHNOLOGIES OY, Espoo (FI)

(72) Inventors: Jianguo LIU, Shanghai (CN); Tao TAO, Shanghai (CN); Yan MENG, Shanghai (CN); Chunli WU, Beijing (CN)

(21) Appl. No.: 19/157,157

(22) PCT Filed: Feb. 16, 2023
(86) PCT No.: PCT/CN2023/076547

§ 371 Date: Aug. 15, 2025

(51) Int. Cl. H04W 68/02; H04L 5/00; H04W 8/22; H04W 64/00

(52) U.S. Cl. CPC H04W 68/02; H04L 5/0051; H04W 8/22; H04W 64/00

(57) ABSTRACT

Example embodiments of the present disclosure relate to methods and apparatuses for paging. A first apparatus obtains paging subgrouping assistance information of a second apparatus, wherein the paging subgrouping assistance information comprises at least one of: a battery lifetime requirement, service information, or a device type. The first apparatus determines a paging subgroup identity for the second apparatus based on the paging subgrouping assistance information. This solution can improve grouping efficiency for power saving and to meet extreme battery lifetime requirements for different devices.

### FIELD

Various example embodiments of the present disclosure generally relate to the field of telecommunication and in particular, to methods, apparatuses and computer readable storage medium for paging.

### BACKGROUND

A wireless network may transmit paging messages to a group of a terminal devices to indicate arrival of downlink information for the terminal devices. If a terminal device is in an idle/inactive state, the terminal device monitors the paging messages and initiates appropriate procedures (e.g. a connection setup procedure). The paging functionality in communication systems can be energy consuming, especially if a terminal device is rarely paged or its paging occasion (PO) suffers from a high false paging alarm rate. Therefore, paging enhancements with paging early indication (PEI) are being developed for power saving, where a terminal can be notified in advance of its target PO whether it must monitor for paging messages at the PO. If the PEI indicates that a terminal device needs not monitor the PO or no PEI indicates that the terminal device needs to monitor the PO, the terminal device may skip the associated PO monitoring and possibly skip synchronization based on system synchronization blocks (SSBs).

### SUMMARY

In a first aspect of the present disclosure, there is provided a first apparatus. The first apparatus comprises one or more processors; and one or more transceivers coupled to the one or more processors, wherein the one or more transceivers are configured with the one or more processors to cause the first apparatus to: obtain paging subgrouping assistance information of a second apparatus, wherein the paging subgrouping assistance information comprises at least one of: a battery lifetime requirement, service information, or a device type; and determine a paging subgroup identity for the second apparatus based on the paging subgrouping assistance information.

In a second aspect of the present disclosure, there is provided a second apparatus. The second apparatus comprises one or more processors; and one or more transceivers coupled to the one or more processors, wherein the one or more transceivers are configured with the one or more processors to cause the second apparatus to: transmit, to a first apparatus or a third apparatus which manages a service of the second apparatus, paging subgrouping assistance information of the second apparatus, wherein the paging subgrouping assistance information comprises at least one of: a battery lifetime requirement, service information, or a device type, and receive, from the first apparatus, an assignment of a paging subgroup identity for the second apparatus.

In a third aspect of the present disclosure, there is provided a method. The method comprises: obtaining, by a first apparatus, paging subgrouping assistance information of a second apparatus, wherein the paging subgrouping assistance information comprises at least one of: a battery lifetime requirement, service information, or a device type; and determining, by the first apparatus, a paging subgroup identity for the second apparatus based on the paging subgrouping assistance information.

In a fourth aspect of the present disclosure, there is provided a method. The method comprises: transmitting, by a second apparatus and to a first apparatus or a third apparatus which manages a service of the second apparatus, paging subgrouping assistance information of the second apparatus, wherein the paging subgrouping assistance information comprises at least one of: a battery lifetime requirement, service information, or a device type, and receiving, by the second apparatus and from the first apparatus, an assignment of a paging subgroup identity for the second apparatus.

In a fifth aspect of the present disclosure, there is provided a first apparatus. The first apparatus comprises means for obtaining paging subgrouping assistance information of a second apparatus, wherein the paging subgrouping assistance information comprises at least one of: a battery lifetime requirement, service information, or a device type; and means for determining a paging subgroup identity for the second apparatus based on the paging subgrouping assistance information.

In a sixth aspect of the present disclosure, there is provided a second apparatus. The second apparatus comprises means for transmitting, to a first apparatus or a third apparatus which manages a service of the second apparatus, paging subgrouping assistance information of the second apparatus, wherein the paging subgrouping assistance information comprises at least one of: a battery lifetime requirement, service information, or a device type, and means for receiving, from the first apparatus, an assignment of a paging subgroup identity for the second apparatus.

In a seventh aspect of the present disclosure, there is provided a first apparatus. The first apparatus comprises one or more processors; and one or more memories storing instructions that, when executed by the one or more processors, cause the first apparatus at least to: obtain paging subgrouping assistance information of a second apparatus, wherein the paging subgrouping assistance information comprises at least one of: a battery lifetime requirement, service information, or a device type; and determine a paging subgroup identity for the second apparatus based on the paging subgrouping assistance information.

In an eighth aspect of the present disclosure, there is provided a second apparatus. The second apparatus comprises one or more processors; and one or more memories storing instructions that, when executed by the one or more processors, cause the second apparatus at least to: transmit, to a first apparatus or a third apparatus which manages a service of the second apparatus, paging subgrouping assistance information of the second apparatus, wherein the paging subgrouping assistance information comprises at least one of: a battery lifetime requirement, service information, or a device type, and receive, from the first apparatus, an assignment of a paging subgroup identity for the second apparatus.

In a ninth aspect of the present disclosure, there is provided a computer readable medium. The computer readable medium comprises instructions stored thereon for causing an apparatus to perform at least the method according to the third aspect.

In a tenth aspect of the present disclosure, there is provided a computer readable medium. The computer readable medium comprises instructions stored thereon for causing an apparatus to perform at least the method according to the fourth aspect.

In an eleventh aspect of the present disclosure, there is provided a computer program comprising instructions which, when executed by an apparatus, cause the apparatus to perform at least the method according to the third aspect.

In a twelve aspect of the present disclosure, there is provided a computer program comprising instructions which, when executed by an apparatus, cause the apparatus to perform at least the method according to the fourth aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIG. 2A illustrates an example diagram showing paging early indication and paging occasion monitoring without subgrouping;

FIG. 2B illustrates an example diagram showing paging early indication and paging occasion monitoring with subgrouping;

FIG. 3 illustrates a signaling flow for communication according to some example embodiments of the present disclosure;

FIG. 4 illustrates a signaling flow for communication according to some further example embodiments of the present disclosure;

FIG. 5 illustrates a flowchart of a method implemented at a first apparatus according to some example embodiments of the present disclosure;

FIG. 6 illustrates a flowchart of a method implemented at a second apparatus according to some example embodiments of the present disclosure;

FIG. 7 illustrates a simplified block diagram of a device that is suitable for implementing example embodiments of the present disclosure; and

FIG. 8 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second” and the like may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the fourth generation (4G), 4.5G, the fifth generation (5G) communication protocols, and/or any other protocols for example 5G beyond. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and/or services the terminal device in a communication network. The network device may refer to at least one of a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an IAB donor node. An IAB node comprises a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

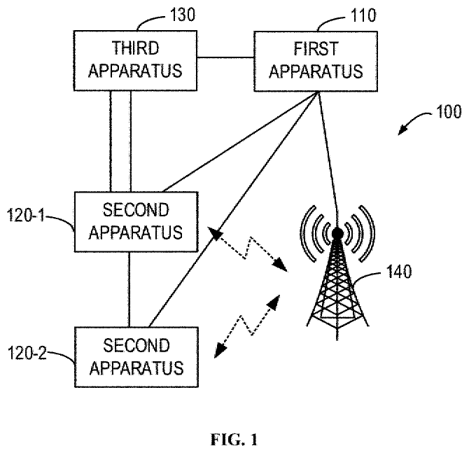

FIG. 1 illustrates an example communication environment 100 in which example embodiments of the present disclosure can be implemented. The communication environment 100 comprises a plurality of communication devices, including a first apparatus 110, one or more second apparatuses 120-1, 120-2, a third apparatus 130, and a fourth apparatus 140 can communicate with each other.

In the example of FIG. 1, the second apparatuses 120 may include terminal devices, and the fourth apparatus 140 may include a network device. A serving area of the second apparatus 120 may be called a cell. The second apparatuses 120 and the fourth apparatus 140 may operate in a radio access network (RAN). Although two terminal devices (second apparatuses) are illustrated, there may be more or less terminal devices within a serving area of the network device.

In some example embodiments, the second apparatuses 120 and/or the fourth apparatus 140 may communicate with network devices (entities/functions) in a core network (CN), for example, with the first apparatus 110 and/or the third apparatus 130. Example embodiments of the present disclosure are generally related to paging subgrouping. The first apparatus 110 may thus be a network function or entity which is configured for paging subgrouping of second apparatuses 120 in the RAN. In some example embodiments, the first apparatus 110 may be an access and mobility management function (AMF) in the CN, although other network entities or functions may also be configured to perform the paging subgrouping in accordance with the example embodiments of the present disclosure. In some example embodiments, the third apparatus 130 may be a network function or entity which is configured to manage a service of one or more second apparatuses 120 to be sub-grouped. In some example embodiments as will be discussed below, one or more second apparatuses 120 may be configured for a positioning service, and in this case the third apparatus 130 may be a location management function (LMF). In other example embodiments, the third apparatus 130 may be any other network entities or functions for other types of service.

Communications in the communication environment 100 may be implemented according to any proper communication protocol(s), comprising, but not limited to, the third generation (3G), the fourth generation (4G), the fifth generation (5G), the sixth generation (6G), and beyond, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

It is to be understood that the number of apparatuses and their connections shown in FIG. 1 are only for the purpose of illustration without suggesting any limitation. The communication environment 100 may include any suitable number of apparatuses configured to implementing example embodiments of the present disclosure. Although not shown, it would be appreciated that one or more additional apparatuses may be located comprised in the communication environment 100. It is noted that although being illustrated as a terminal device, the second apparatus 120 may be other device than a terminal device. Although being illustrated as network devices, the first apparatus 110, the third apparatus 130, and the fourth apparatus 140 may be other device than a network device.

In the following, for the purpose of illustration, some example embodiments are described with the first apparatus 110 operating as a terminal device and the second apparatus 120 and the third device 130 operating as network devices. However, in some example embodiments, operations described in connection with a terminal device may be implemented at a network device or other device, and operations described in connection with a network device may be implemented at a terminal device or other device.

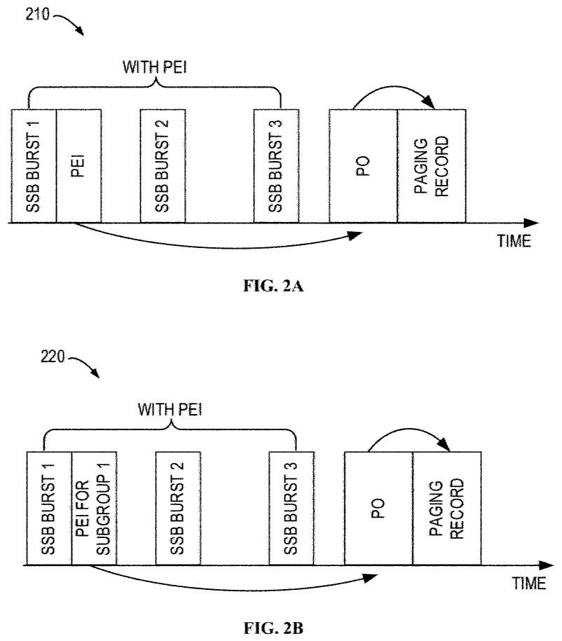

In the context of paging, a second apparatus 120, e.g., in an idle/inactive state (RRC_IDLE/RRC_INACTIVE state), may monitor paging occasions (POs), to receive paging messages from the fourth apparatus 140. A paging occasion represents a time interval or a time window during which a group of second apparatuses monitor paging information (paging downlink control information, DCI), and the fourth apparatus 140 may page one user equipment within one paging occasion. To further save power consumption, a paging early indication (PEI) is used to notify in advance a second apparatus 120 of its target PO whether it must monitor for paging information at the PO. The PEI may comprise wakeup signaling for paging for the second apparatus 120. A second apparatus 120 which is not indicated by the PEI can skip synchronization based on SSBs and the associated PO monitoring. In some example embodiments, the PEI can be signalled via a DCI message carried in the Physical Downlink Control Channel (PDCCH). In some example embodiments, DCI format 2_7 may be used for notifying the paging early indication for one or more second apparatuses. It would be appreciated that the PEI may be signaled through other ways, such as through a sequence. FIG. 2A illustrates an example 210 showing paging early indication and paging occasion monitoring without subgrouping. As shown, without subgrouping, a second apparatus 120 needs to receive one to three SSB bursts before a PO for time-frequency synchronization based on Signal to Interference plus Noise Ratio (SINR). If a second apparatus 120 supports PEI and is indicated not to monitor a PO by the PEI received after a SSB burst (SSB Burst 1 in the example of FIG. 2A), it can skip the subsequent PO monitoring and synchronization based on the following SSB bursts (SSB Burst 2 and SSB Burst 3) for power saving. And thus, the second apparatus 120 may not need to receive the paging record.

Furthermore, sub-grouping information can be indicated in PEI to indicate which subgroups of second apparatuses 120 are to be paged. FIG. 2B illustrates an example 220 showing paging early indication and paging occasion monitoring with subgrouping. A second apparatus 120 may monitor the corresponding PO if the associated PEI indicates that the sub-group of the second apparatus 120 is paged. If its subgroup is not paged, the second apparatus 120 may skip DCI and paging message reception, which would result in lower group paging rate and fewer false paging alarms. As illustrated in FIG. 2B, only second apparatuses 120 of Subgroup 1 monitor the PO and second apparatuses 120 of other subgroups can skip the PO and also the SSB bursts, for power saving.

It is noted that currently there is only one Paging Radio Network Temporary Identity (P-RNTI), which means all apparatuses of a PO may have to receive the paging record if at least one second apparatus is to be paged. In this case, there is a false paging alarm for all the other second apparatuses.

Currently, CN-assigned subgrouping (also referred to as CN-controlled subgrouping) and device-identity (e.g., UE ID)-based subgrouping are supported for paging with PEI. The CN-assigned subgrouping may be considered as non-access stratum (NAS) capability, and the device-identity-based subgrouping is considered as radio capability.

If a second apparatus 120 supports CN-assigned subgrouping, a network function or entity in CN (e.g., the first apparatus 110) determines a paging subgroup ID assignment for the second apparatus 120 and then send the subgroup ID to the second apparatus 120, for example, via NAS signaling. At the same time, the first apparatus 110 informs the fourth apparatuses 140 about the CN-assigned subgroup ID for paging the second apparatus 120 in the idle/inactive state. Before the second apparatus 120 is paged in the PO, the fourth apparatuses 140 transmits the associated PEI and indicates the corresponding CN-assigned subgroup of the second apparatus 120 that is to be paged in the PEI.

As for the device-identity-based subgrouping, a network function or entity (e.g., the fourth apparatus 140) may determine and broadcast the total number of subgroups for device-identity-based subgrouping in a cell. Then a second apparatus 120 can determine its subgroup in the cell based on the total number of the subgroups and its device ID. Before the second apparatus 120 is paged in the PO, the fourth apparatus 140 transmits the associated PEI and indicates the corresponding subgroup derived based on the device identity of the fourth apparatus 140 that is to be paged in the PEI.

In some example embodiments, the RRC state (RRC_IDLE/RRC_INACTIVE) may not impact which subgroup a second apparatus belongs to.

The paging functionality and the paging early indication are both used for the purpose of power consumption saving. There are some devices in the wireless communications systems which have strict requirements on energy consumption, one example of which is the low-power high-accuracy positioning (LPHAP) device. It is noted that although “LPHAP” is used herein, such a device which has a strict power saving requirement may be referred to as other terminologies.

Low power high accuracy positioning is an integral part of a considerable number of industrial applications. The total energy needed for a specific operation time for such LPHAP devices is a combination of energy for positioning (varies depending on the used positioning method), energy for communication/synchronization and a difficult to predict factor to take additional losses through e.g. security, power management, microcontroller, and self-discharge of batteries into account. Examples of target applications for low power high accuracy positioning are asset tracking in process automation, tracking of vehicles, and tool tracking.

LPHAP devices have very challenged battery lifetime requirements. Table 1 gives an example of the required battery lifetime requirements of the LPHAP devices for different use cases.

TABLE 1
Low power high accuracy positioning use cases

| | | | Corresponding | Positioning | | | |
|---|---|---|---|---|---|---|---|
| Use | Horizontal | | service level | interval/ duty | | battery lifetime/ | |
| Case # | accuracy | | (22.261) | cycle | | minimum operation time | |
| 1 | 10 | m | Service Level 1 | on request | | 24 | months |
| 2 | 2 m to 3 m | | Service Level 2 | <4 | seconds | >6 | months |
| 3 | <1 | m | Service Level 3 | no indication | | 1 work shift - 8 hours (up | |
| | | | | | | to 3 days, 1 month for | |
| | | | | | | inventory purposes) | |
| 4 | <1 | m | Service Level 3 | 1 | second | 6-8 | years |
| 5 | <1 | m | Service Level 3 | 5 seconds-15 | | 18 | months |
| | | | | minutes | | | |
| 6 | <1 | m | Service Level 3 | 15 s to 30 s | | 6-12 | months |
| 7 | 30 | cm | Service Level 5 | 250 | ms | 18 | months |

| | | | | | | |
|---|---|---|---|---|---|---|
| 8 | 30 | cm | Service Level 5 | 1 | second | 6-8 years (no strong |
| | | | | | | limitation in battery size) |
| 9 | 10 | m | Service Level 1 | 20 | minutes | 12 years |
| | | | | | | (@20 mJ/position fix) |

It has been studied and concluded that the existing positioning for terminal devices in RRC_INACTIVE state cannot satisfy the target battery life required by LPHAP use case 6 and higher in most of the evaluation scenarios that were examined. Therefore, the power saving mechanism needs to be further enhanced, at least for LPHAP devices, to meet the power consumption requirement.

According to legacy communication mechanism, terminal devices in RRC_IDLE/RRC_INACTIVE wake up periodically to monitor PDCCH at its POs. This is quite power consuming if a terminal device is rarely paged and the false paging alarm rate is high when other terminal devices with the same PO is paged. As discussed above, Paging Early Indication (PEI) with subgrouping is defined to reduce false paging alarm rate for power saving. To meet the strict battery lifetime requirement of some apparatuses (e.g., the LPHAP devices), a candidate solution is to apply the PEI with subgrouping to reduce the false paging rate and thus save device power.

However, the existing subgrouping methods may need further study for power saving enhancements. For device-identity-based subgrouping, in general, the device ID allocation would not consider the characteristics of the terminal device. Therefore, it is hard for the network device to control the subgroup assignment and it is likely that multiple devices with different types and/or paging probabilities are allocated in the same subgroup. Obviously, the solution is not beneficial to reduce false paging alarm for devices with strict power saving requirements.

For CN-assigned subgrouping, the AMF determines the subgroup ID assignment for the terminal device. However, it is up to CN implementation in the current specification on how to group terminal devices for paging monitoring. A straightforward solution for AMF is to group the UEs based on their paging probabilities. According to analysis of the inventors, this paging subgrouping solution may face the following challenges for devices with challenged battery lifetime requirements (e.g., at least for LPHAP devices).

Different from other terminal devices, LPHAP devices have strict battery target lifetime requirements in different positioning use cases. If the paging subgrouping is based on the paging probability, it is possible that some LPHAP devices cannot meet the battery lifetime requirement in the case of high paging probability which would cause high power consumption for paging monitoring. It thus needs to study how to meet the battery lifetime requirements of the LPHAP devices with high paging probability for paging subgrouping.

Further, in traditional paging procedures, PEI with subgrouping manages to reduce false paging alarm rate by mapping the terminal devices into multiple subgroups. Even so, the false paging for devices is still not avoided as the terminal devices needs to monitor the paging message based on PEI if there is page message for any terminal device in the same subgroup. This reason is that the traffic arrival time is still randomized for different terminal devices and thus the devices can still suffer from a high false paging alarm rate.

To achieve more energy saving for certain devices, it is beneficial to provide an enhanced mechanism for assigning the subgroup ID for the devices.

According to some example embodiments of the present disclosure, there is provided an improved solution for paging subgrouping. This solution may be directed to CN-assigned subgrouping. In this solution, a first apparatus can receive paging subgrouping assistance information of a second apparatus, which indicates information related to the second apparatus, to assist the first apparatus in determining a suitable subgroup for paging the second apparatus.

Through this solution, the paging subgrouping assistance information would be helpful for determining the paging subgrouping assignment for the second apparatuses, thus can improve grouping efficiency for power saving and to meet extreme battery lifetime requirements for different devices.

Example embodiments of the present disclosure will be described in detail below with reference to the accompanying drawings.

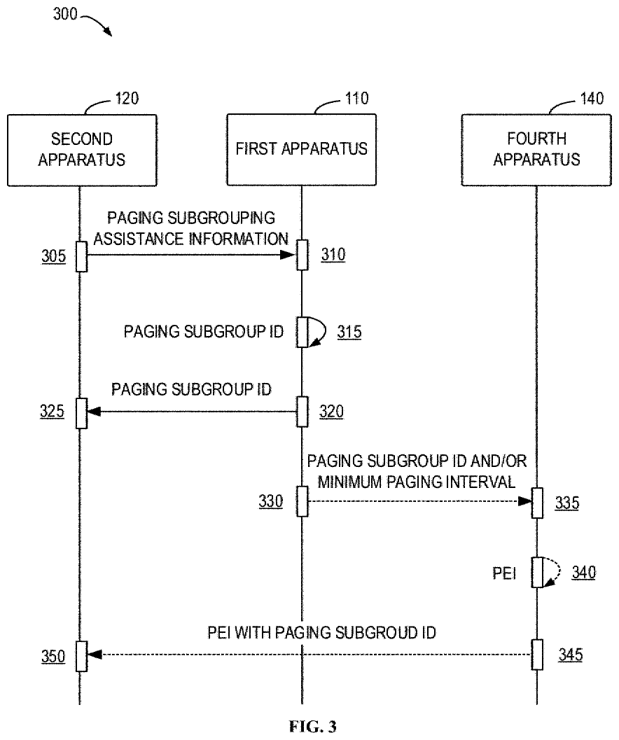

Reference is now made to FIG. 3, which shows a signaling flow 300 for communication according to some example embodiments of the present disclosure. As shown in FIG. 3, the signaling flow 300 involves a first apparatus 110, a second apparatus 130, and a fourth apparatus 140. For the purpose of discussion, reference is made to FIG. 1 to describe the signaling flow 300.

In the signaling flow 300, it is assumed that the first apparatus 110 is configured for paging subgrouping assignment for the second apparatus 120. The first apparatus 110 may be, for example, a CN network function or entity, such as the AMF. The second apparatus 120 may be a device to be paged in a communication area, such as a terminal device, e.g., an LPHAP device. The fourth apparatus 140 may be a device (e.g., a network device) which is configured to page the second apparatus 120.

In the signaling flow 300, the first apparatus 110 obtains (310) paging subgrouping assistance information of the second apparatus 120. In the example embodiments of FIG. 3, the second apparatus 120 transmits (305) the paging subgrouping assistance information to the first apparatus 110. The first apparatus 110 may thus receive the paging subgrouping assistance information from the second apparatus 120. In some example embodiments, the paging subgrouping assistance information may be transmitted to the first apparatus 110 via NAS signaling. In some example embodiments, the paging subgrouping assistance information may be provided by the second apparatus 120 to the first apparatus 110 after receiving a request from the network side, for example, from the first apparatus 110.

The paging subgrouping assistance information at least comprises one or more of the following: a battery lifetime requirement, service information, or a device type of the second apparatus 120.

The battery lifetime requirement indicates a battery lifetime or a minimum operation time required by the second apparatus 120. The battery lifetime requirement for the second apparatus 120 may be varied depending on the use cases of the second apparatus 120, e.g., one month or 24 months. One example of the battery lifetime requirements for different use cases of LPHAP devices is in above Table 1. Since false paging of the second apparatus 120 may consume energy, the first apparatus 110 may take the battery lifetime requirement into account in paging subgrouping, so as to meet the battery lifetime requirement in a best way possible.

In some example embodiments, the device type may indicate whether the second apparatus 120 is an LPHAP device. In some example embodiments, the device type may further indicate one or more other device types. Different types of devices may be grouped in different ways.

The service information for the second apparatus 120 may indicate related information of a service provided by the second apparatus 120. In some example embodiments, if a service of the second apparatus 120 is a positioning service, the service information may indicate at least one of the following: a positioning service level, a positioning interval, a positioning reference signal (PRS) configuration update interval, and/or the like. The service information may indicate potential traffic and/or control information transmissions to/from the second apparatus 120. A positioning service level may indicate the use case number for positioning, a positioning accuracy requirement, and/or a corresponding service level. A positioning interval may indicate a duty cycle for positing. In some example embodiments, the service information may alternatively or additionally indicate grouping information of the second apparatus 120 for a service. For example, if the second apparatus 120 is grouped with one or more other second apparatuses 120 for provisioning a service, then those apparatuses may be grouped together for paging.

In some example embodiments, the second apparatus 120 may alternatively or additionally provide further paging subgrouping assistance information to facilitate paging subgrouping at the first apparatus 110. The paging subgrouping assistance information may further comprise, for example, a device identity (e.g., UE ID), a paging probability, a minimum paging interval (if available), a recommended subgroup (if available), a subgrouping request (if available) for a certain device type (e.g., for an LPHAP device), and/or the like. The paging probability may, for example, be estimated based on e.g., the traffic statistical information or the positioning assistance information update period for the second apparatus 120. In some example embodiments, in the case that the first apparatus 110 may not map the LPHAP devices based on the device type by default, a subgrouping request is to request the first apparatus 110 to subgroup the second apparatus 120 based on its device type (e.g., LPHAP device type).

With the paging subgrouping assistance information obtained, the first apparatus 110 determines (315) a paging subgroup identity (ID) for the second apparatus 120 based on the obtained paging subgrouping assistance information of the second apparatus 120. In example embodiments of the present disclosure, the first apparatus 110 can map one or more second apparatuses 120 (including LPHAP devices) into one or more paging subgroups based on the paging subgrouping assistance information. In some example embodiments, the first apparatus 110 can obtain the paging subgrouping assistance information of multiple second apparatuses 120 (of the same or different device types) for paging subgrouping, and then determine how to map those multiple second apparatuses 120 into one or more paging subgroups.

In some example embodiments, the first apparatus 110 may map the second apparatuses 120 of a certain type (e.g., the LPHAP devices) to one or more subgroups which belongs to the same device type. The first apparatus 110 may identify which second apparatuses are LPHAP devices based on the device type and map the LPHAP devices to one or more subgroups which belongs to the same device type.

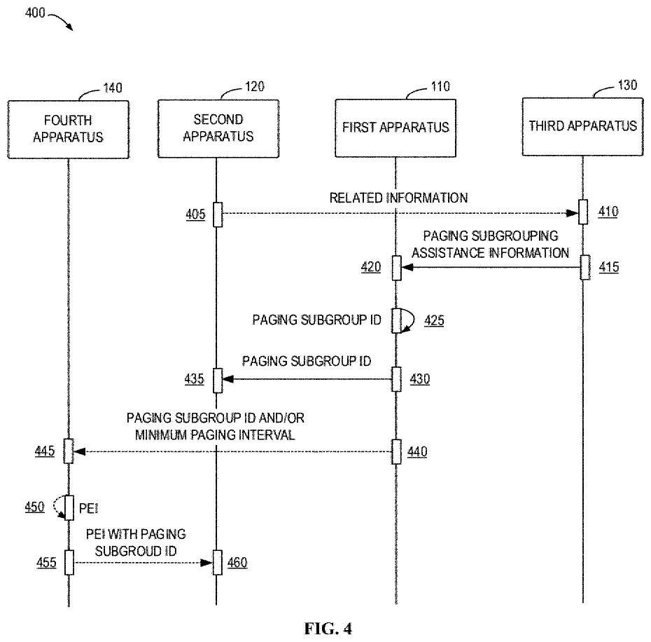

In some example embodiments, the paging subgrouping may be performed based on an indication of the device type as LPHAP device by default. Alternatively, or in addition, the paging subgrouping may be triggered after receiving the paging subgrouping assistance information from the second apparatus 120 (and/or from the third apparatus 130 as will be discussed below in detail with reference to FIG. 4) or after receiving a subgrouping request from the second apparatus 120 or the third apparatus 130. For example, the paging subgrouping may be triggered for the specified second apparatus 120 or all the second apparatus of a same type (e.g., the LPHAP devices) after receiving the paging subgrouping request or the paging subgrouping assistance information.

In some example embodiments, the first apparatus 110 may determine the paging subgroup assignment for the second apparatus 120 based on the paging subgrouping assistance information in any suitable ways depending on implementations. As an example, the first apparatus 110 may map the second apparatuses 120 whose battery lifetime requirement belongs to a certain rang to the same paging subgroup and then determine a minimum paging interval for the subgroup of second apparatuses so as to satisfy the strict battery lifetime requirement. As another example, the first apparatus 110 may obtain a paging probability of the second apparatus 120 based on the traffic statistic information of the second apparatuses 120 and/or through the paging subgrouping assistance information obtained, and then map the second apparatuses 120 whose paging probability is within a certain range to the same paging subgroup. As a further example, the first apparatus 110 may map the second apparatuses 120 whose PRS configuration update interval is within a certain range to the same paging subgroup.

In a yet further example, the the first apparatus 110 may map the second apparatuses 120 to a corresponding paging subgroup based on the recommended subgroup indicated in the paging subgrouping assistance information. As a further example, the first apparatus 110 may map the second apparatuses 120 to one or more paging subgroups taking into account the service information (e.g., the positioning interval, the paging probability), the battery lifetime requirement, and/or the like.

It would be appreciated that the above examples are provided for the purpose of illustration only. The paging subgrouping of the second apparatuses may be determined based on any combination of the factors comprised in the paging subgrouping assistance information and/or other information (e.g., local statistical information related to the second apparatuses).

In some example embodiments, the second apparatus 120 may transmit, to the first apparatus 110, capability information of the second apparatus 120. The capability information may indicate support of network-controlled subgrouping, e.g., support of CN-assigned subgrouping. In some example embodiments, the capability information may be provided to the first apparatus 110 via NAS signaling. In the case that the second apparatus 120 supports network-controlled subgrouping, the first apparatus 110 may determine a paging subgrouping ID for the second apparatus 120. In some example embodiments, the capability information and the paging subgrouping assistance information may be transmitted in a same message to the first apparatus 110.

In some example embodiments, after determining a paging subgroup for a second apparatus 120, the first apparatus 110 may assign (320) the determined paging subgroup ID to the second apparatus 120. In some example embodiments, the paging subgroup ID may be transmitted, for example, via NAS signaling. The second apparatus 120 thus receives (325) the assignment of the paging subgroup ID, which may be used at least for PEI reception.

In some example embodiments, the first apparatus 110 may determine a minimum paging interval (or paging interval) for paging the second apparatus 120, for example, in an idle/inactive state. The determination of the minimum paging interval may be based on the paging subgrouping assistance information, at least based on a battery lifetime requirement of the second apparatus 120. In some example embodiments, the minimum paging interval may be determined to meet the battery lifetime requirement. In some example embodiments, the minimum paging interval may be provided to the first apparatus 110 from another apparatus, such as the third apparatus 130 which manages a service of the second apparatus 120. For example, the minimum paging interval may be provided through paging subgrouping assistance information from the third apparatus 130. Some example embodiments related to providing paging subgrouping assistance information of the second apparatus 120 by the third apparatus 130 will be discussed below.

In some example embodiments, the first apparatus 110 may transmit (330), to the fourth apparatus 140, the paging subgroup ID for the second apparatus 120 and/or a minimum paging interval for the second apparatus 120. The fourth apparatus 140 may receive (335), from the first apparatus 110, the paging subgroup ID and/or a minimum paging interval for the second apparatus 120. In some example embodiments, as an alternative, the third apparatus 130 may signal the minimum paging interval for the second apparatus 120 to the fourth apparatus 140 (which serves the second apparatus 120). In some example embodiments, as an alternative, the third apparatus 130 may provide the paging subgroup ID for the second apparatus 120 to the fourth apparatus 140.

In some example embodiments, the fourth apparatus 140 may determine (340) a PEI for the second apparatus 120 based on the paging subgroup ID for the second apparatus 120. If the minimum paging interval for the second apparatus 120 is available for the fourth apparatus 140, it may determine the PEI for the second apparatus 120 further based on the minimum paging interval. The fourth apparatus 140 may determine to transmit the PEI for the subgroup of second apparatus if there is paging message(s) for any second apparatus in the same paging subgroup by taking the minimum paging interval into account. The paging message(s) for a second apparatus may be received from the CN, or generated at the fourth apparatus 140, or obtained from any other source.

Specifically, in some example embodiments, the fourth apparatus 140 may determine a PO and the associated PEI occasion for the second apparatus 120 by taking the minimum paging interval into account so as to meet the paging interval requirement (e.g., the minimum paging interval) for the paging subgroup. For example, if there is a paging message(s) for any second apparatus in the same paging subgroup and the paging interval for this subgroup is larger than the minimum paging interval, the fourth apparatus 140 may determine to transmit a PEI for the subgroup of second apparatuses at the configured PEI occasion associated with the PO. If there is paging message(s) for any second apparatus in the same paging subgroup but the paging interval is less than the minimum paging interval, the fourth apparatus 140 may buffer the paging message(s) for the subgroup of second apparatuses and may not transmit a PEI for the subgroup of second apparatuses at the PEI occasion.

The fourth apparatus 140 may transmit (345) the PEI before a PO for paging the second apparatus 120. If the fourth apparatus 140 determines to page the second apparatus 120, the assigned paging subgroup ID of the second apparatus 120 may be indicated in the PEI. At an associated PEI occasion, the second apparatus 120 may receive (350) the PEI. In some example embodiments, the second apparatus 120 may be in an idle or inactive state and may wake up at the PEI occasion to receive the PEI. If the assigned paging subgroup ID of the second apparatus 120 is indicated in the PEI, the second apparatus 120 may continue to monitor a page message in the associated PO. Otherwise, it can skip the subsequent PO monitoring and synchronization for power saving.

Reference is now made to FIG. 4, which shows a signaling flow 400 for communication according to some further example embodiments of the present disclosure. As shown in FIG. 4, the signaling flow 400 involves a first apparatus 110, a second apparatus 140, a third apparatus 130, and a fourth apparatus 140. For the purpose of discussion, reference is made to FIG. 1 to describe the signaling flow 400.

In the signaling flow 400, it is assumed that the third apparatus 130 manages a service of the second apparatus 120. The first apparatus 110, the second apparatus 140, and the fourth apparatus 140 are similar as those in the signaling flow 300.

As an alternative or as an additional solution to the signaling flow 300, the first apparatus 110 in the signaling flow 400 obtains (420) paging subgrouping assistance information of the second apparatus 120 from the third apparatus 130. The third apparatus 130 transmits (415) the paging subgrouping assistance information of the second apparatus 120 to the first apparatus 110 via any suitable interface, e.g., through NAS signaling.

In some example embodiments, the paging subgrouping assistance information of the second apparatus 120 may comprise at least one of: a battery lifetime requirement, service information, or a device type of the second apparatus 120. In some example embodiments, the paging subgrouping assistance information of the second apparatus 120 may further comprise, for example, a device identity (e.g., UE ID), a paging probability, a minimum paging interval (if available), a recommended subgroup (if available), a subgrouping request (if available) for a certain device type (e.g., for an LPHAP device), and/or the like.

In some example embodiments, as a server of the second apparatus 120, the third apparatus 130 may obtain information related to the second apparatus 120. In some example embodiments, alternatively or in addition, the second apparatus 120 may transmit (405) the related information to the third apparatus 130. The third apparatus 130 may receive (410) the related information via any suitable interface with the second apparatus 120.

The related information of the second apparatus 120 may indicate at least one of the following: service information, or a traffic pattern of the second apparatus 120. In some examples, the service information, as mentioned above, may indicate at least one of the following: a positioning service level, a positioning interval, grouping information of the second apparatus for a service, or a positioning reference signal configuration update interval.

The third apparatus 130 may determine, based on the obtained information related to the second apparatus 120, at least a part of the paging subgrouping assistance information of the second apparatus 120. In some example embodiments, the determined paging subgrouping assistance information may indicate at least one of the following: a minimum paging interval, a recommended subgroup, or a subgrouping request.

Specially, in some example embodiments, the third apparatus 130 may determine a recommended subgroup for the second apparatus 120 based on the service information, the battery lifetime requirement of the second apparatus 120, grouping information of the second apparatus 120 in a service, a traffic pattern of the second apparatus 120, the device type, the paging probability and/or the like. The recommended subgroup determined by the third apparatus 120 is considered as a subgrouping recommendation for the first apparatus 110, and the first apparatus 110 may follow this recommendation or determine the paging subgrouping in combination with other factors. In some example embodiments, the grouping information and/or the traffic pattern for the second apparatus 120 may be obtained from the service application which can be utilized by the third apparatus 130 to determine the recommended subgroup.

In some example embodiments, the third apparatus 130 may determine the minimum paging interval, the recommended subgroup based on the capability or/and the positioning service of the second apparatus 120. In some example embodiments, the third apparatus 130 may determine the minimum paging interval for a second apparatus 120 to meet the battery lifetime requirement of the second apparatus 120.

In some example embodiment, the traffic pattern of the second apparatus 120 may also be useful in determining the paging subgrouping assistance information of the second apparatus 120, such as the recommended subgroup, the subgrouping request, and/or the minimum paging interval. The traffic pattern may be determined based on traffic statistical information of the second apparatus 120. Generally, if the traffic arrival time is still randomized for different second apparatuses within a same paging subgroup, thus the second apparatuses may suffer from a high false paging alarm rate. If the paging message generation for the second apparatuses in the same subgroup has the similar pattern, the false paging alarm rate will be greatly decreased. In an example application scenario, a group of second apparatuses can be configured with the same positioning interval, and the application can be triggered to transmit data (e.g., control signaling or location info) to the subgroup of second apparatuses based on update of their location. In this case, the false paging alarm rate will be reduced if these second apparatuses can be grouped together for paging monitoring. For this, it makes sense to map these second apparatuses into the same subgroup.

In some example embodiments, the second apparatus 120 may transmit its capability information to the third apparatus 130, to indicate whether the second apparatus 120 supports network-controlled subgrouping, i.e., CN-assigned subgrouping. In the case that the second apparatus 120 supports the CN-assigned subgrouping, the third apparatus 130 transmits the paging subgrouping assistance information of the second apparatus 120 to the first apparatus 120 to facilitate the CN-assigned subgrouping for the second apparatus 120.

The first apparatus 110 determines (425) a paging subgroup ID for the second apparatus 120 based on the paging subgrouping assistance information received from the third apparatus 130. In some example embodiments, if the second apparatus 120 also transmits paging subgrouping assistance information to the first apparatus 110, the first apparatus 110 may determine the paging subgroup ID for the second apparatus 120 based on the paging subgrouping assistance information from both sources. Some example embodiments of determining the paging subgroup ID for the second apparatus 120 may refer to the example embodiments discussed above with reference to FIG. 3, which are omitted here.

The first apparatus 110 transmits (430), to the second apparatus, an assignment of the paging subgroup ID for the second apparatus 120. The second apparatus 120 receives (435) the assignment of the paging subgroup ID and may apply it for PEI reception. In some example embodiments, the first apparatus 110 may further transmit (440), to the fourth apparatus 140, the paging subgroup ID and/or a minimum paging interval for the second apparatus 120.

The fourth apparatus 140 may receive (445) the paging subgroup ID and/or a minimum paging interval for the second apparatus 120 and determine (450) a PEI for the second apparatus based on the minimum paging interval and the paging subgroup identity for the second apparatus 120. The fourth apparatus 140 may transmit (455) the PEI before a PO for paging the second apparatus 120. If the fourth apparatus 140 determines to page the second apparatus 120, the assigned paging subgroup ID of the second apparatus 120 may be indicated in the PEI. At an associated PEI occasion, the second apparatus 120 may receive (460) the PEI based on its paging subgroup ID.

It would be appreciated that the operations from 425 to 460 in the signaling flow 400 may be similar as the operations from 315 to 350 in the signaling flow 300, and the details may be omitted for brevity.

According to example embodiments of the present disclosure, the NW (e.g., the AMF) can map the terminal devices to one or more paging subgroups based on the service type indication of terminal devices provided by the LMF or the terminal devices, which can facilitate power saving of the terminal devices, so as to meet their extreme battery lifetime requirements. The paging subgroup assignment can be determined based on the paging subgrouping assistance information, which can help reduce the false paging alarm rate so as to efficiently reduce power consumption of the terminal devices for paging monitoring.

FIG. 5 shows a flowchart of an example method 500 implemented at a first apparatus in accordance with some example embodiments of the present disclosure. For the purpose of discussion, the method 500 will be described from the perspective of the first apparatus 110 in FIG. 1

At block 510, the first apparatus 110 obtains paging subgrouping assistance information of a second apparatus (e.g., the second apparatus 120 in FIG. 1), wherein the paging subgrouping assistance information comprises at least one of: a battery lifetime requirement, service information, or a device type.

At block 520, the first apparatus 110 determines a paging subgroup identity for the second apparatus based on the paging subgrouping assistance information.

In some example embodiments, the method 500 further comprises: assigning the paging subgroup identity to the second apparatus.

In some example embodiments, the paging subgrouping assistance information further comprises at least one of the following: a device identity, a minimum paging interval, a recommended subgroup, a subgrouping request, or a paging probability.

In some example embodiments, the service information indicates at least one of the following: a positioning service level, a positioning interval, grouping information of the second apparatus for a service, or a positioning reference signal configuration update interval, and wherein the device type indicates whether the second apparatus is a low-power high-accuracy positioning, LPHAP, device.

In some example embodiments, the method 500 further comprises: obtaining the paging subgrouping assistance information by: receiving the paging subgrouping assistance information from the second apparatus; or receiving the paging subgrouping assistance information from a third apparatus which manages a service of the second apparatus.

In some example embodiments, the second apparatus 120 comprises an LPHAP device. In some example embodiments, the third apparatus 130 comprises a location management function, LMF.

In some example embodiments, the method 500 further comprises: transmitting, to a network device which is configured to page the second apparatus, at least one of the following: the paging subgroup identity for the second apparatus, or a minimum paging interval for the second apparatus.

In some example embodiments, the method 500 further comprises: determining the minimum paging interval based on the paging subgrouping assistance information.

In some example embodiments, the first apparatus 110 comprises an access and mobility management function, AMF.

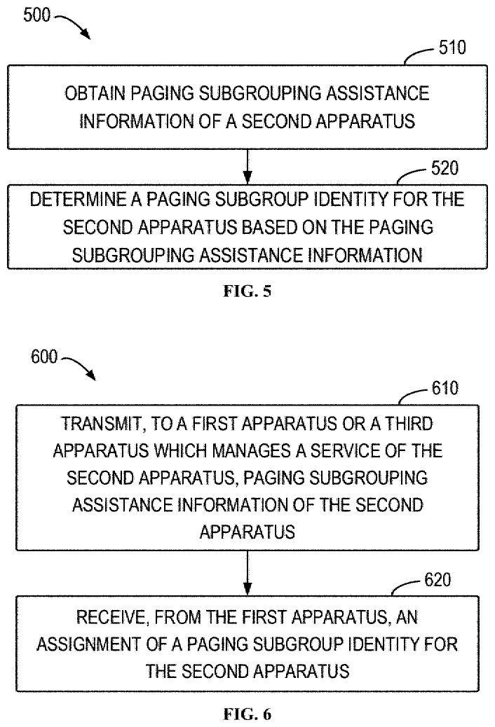

FIG. 6 shows a flowchart of an example method 600 implemented at a second apparatus in accordance with some example embodiments of the present disclosure. For the purpose of discussion, the method 600 will be described from the perspective of the second apparatus 120 in FIG. 1.

At block 610, the second apparatus 120 transmits, to a first apparatus (e.g., the first apparatus 110 in FIG. 1) or a third apparatus (e.g., the third apparatus 130 in FIG. 1) which manages a service of the second apparatus, paging subgrouping assistance information of the second apparatus, wherein the paging subgrouping assistance information comprises at least one of: a battery lifetime requirement, service information, or a device type.

At block 620, the second apparatus 120 receives, from the first apparatus, an assignment of a paging subgroup identity for the second apparatus.

In some example embodiments, the paging subgrouping assistance information further comprises at least one of the following: a device identity, a minimum paging interval, a recommended subgroup, a subgrouping request, or a paging probability.

In some example embodiments, the service information indicates at least one of the following: a positioning service level, a positioning interval, grouping information of the second apparatus for a service, or a positioning reference signal configuration update interval, and wherein the device type indicates whether the second apparatus is a low-power high-accuracy positioning, LPHAP, device.

In some example embodiments, the first apparatus 110 comprises an access and mobility management function, AMF. In some example embodiments, the second apparatus comprises an LPHAP device, and wherein the third apparatus comprises a location management function, LMF.

In some example embodiments, the method further comprises: transmitting, to the third apparatus, capability information of the second apparatus, wherein the capability information indicates support of network controlled subgrouping.

In some example embodiments, a first apparatus capable of performing any of the method 500 (for example, the first apparatus 110 in FIG. 1) may comprise means for performing the respective operations of the method 500. The means may be implemented in any suitable form. For example, the means may be implemented in a circuitry or software module. The first apparatus may be implemented as or included in the first apparatus 110 in FIG. 1.

In some example embodiments, the first apparatus comprises means for obtaining paging subgrouping assistance information of a second apparatus, wherein the paging subgrouping assistance information comprises at least one of: a battery lifetime requirement, service information, or a device type; and means for determining a paging subgroup identity for the second apparatus based on the paging subgrouping assistance information.

In some example embodiments, the first apparatus further comprises: means for assigning the paging subgroup identity to the second apparatus.

In some example embodiments, the paging subgrouping assistance information further comprises at least one of the following: a device identity, a minimum paging interval, a recommended subgroup, a subgrouping request, or a paging probability.

In some example embodiments, the service information indicates at least one of the following: a positioning service level, a positioning interval, grouping information of the second apparatus for a service, or a positioning reference signal configuration update interval, and wherein the device type indicates whether the second apparatus is a low-power high-accuracy positioning, LPHAP, device.

In some example embodiments, the first apparatus further comprises: means for obtaining the paging subgrouping assistance information by: means for receiving the paging subgrouping assistance information from the second apparatus; or means for receiving the paging subgrouping assistance information from a third apparatus which manages a service of the second apparatus.

In some example embodiments, the second apparatus comprises an LPHAP device, and wherein the third apparatus comprises a location management function, LMF.

In some example embodiments, the first apparatus further comprises: means for transmitting, to a network device which is configured to page the second apparatus, at least one of the following: the paging subgroup identity for the second apparatus, or a minimum paging interval for the second apparatus.

In some example embodiments, the first apparatus further comprises: means for determining the minimum paging interval based on the paging subgrouping assistance information.

In some example embodiments, the first apparatus comprises an access and mobility management function, AMF.

In some example embodiments, the first apparatus further comprises means for performing other operations in some example embodiments of the method 500 or the first apparatus 110. In some example embodiments, the means comprises at least one processor; and at least one memory storing instructions that, when executed by the at least one processor, cause the performance of the first apparatus.

In some example embodiments, a second apparatus capable of performing any of the method 600 (for example, the second apparatus 120 in FIG. 1) may comprise means for performing the respective operations of the method 600. The means may be implemented in any suitable form. For example, the means may be implemented in a circuitry or software module. The second apparatus may be implemented as or included in the second apparatus 120 in FIG. 1.

In some example embodiments, the second apparatus comprises means for transmitting, to a first apparatus or a third apparatus which manages a service of the second apparatus, paging subgrouping assistance information of the second apparatus, wherein the paging subgrouping assistance information comprises at least one of: a battery lifetime requirement, service information, or a device type, and means for receiving, from the first apparatus, an assignment of a paging subgroup identity for the second apparatus.

In some example embodiments, the paging subgrouping assistance information further comprises at least one of the following: a device identity, a minimum paging interval, a recommended subgroup, a subgrouping request, or a paging probability.

In some example embodiments, the service information indicates at least one of the following: a positioning service level, a positioning interval, grouping information of the second apparatus for a service, or a positioning reference signal configuration update interval, and wherein the device type indicates whether the second apparatus is a low-power high-accuracy positioning, LPHAP, device.

In some example embodiments, the first apparatus comprises an access and mobility management function, AMF, wherein the second apparatus comprises an LPHAP device, and wherein the third apparatus comprises a location management function, LMF.

In some example embodiments, the second apparatus further comprises: means for transmitting, to the third apparatus, capability information of the second apparatus, wherein the capability information indicates support of network controlled subgrouping.

In some example embodiments, the second apparatus further comprises means for performing other operations in some example embodiments of the method 600 or the second apparatus 120. In some example embodiments, the means comprises at least one processor; and at least one memory storing instructions that, when executed by the at least one processor, cause the performance of the second apparatus.

FIG. 7 is a simplified block diagram of a device 700 that is suitable for implementing example embodiments of the present disclosure. The device 700 may be provided to implement a communication device, for example, the first apparatus 110, the second apparatus 120, the third apparatus 130, or the fourth apparatus 140 as shown in FIG. 1. As shown, the device 700 includes one or more processors 710, one or more memories 720 which may couple to the processor 710, and one or more communication modules 740 which may couple to the processor 710.

The communication module 740 is for bidirectional communications. The communication module 740 has one or more communication interfaces to facilitate communication with one or more other modules or devices. The communication interfaces may represent any interface that is necessary for communication with other network elements. In some example embodiments, the communication module 740 may include at least one antenna. The communication interface may be hardware or software based interface. For example, the communication interface may be one or more transceivers. The one or more transceivers may be coupled to one or more antennas or antenna ports to wirelessly transmit and/or receive communication signals. The antennas or antenna ports may be the same or different types. The antennas or antenna ports may be located in different positions of an apparatus. The one or more transceivers allow the apparatus to communicate with other devices that may be wired and/or wireless. The transceiver may support one or more radio technologies. For example, the one or more transceivers may include a cellular subsystem, a WLAN subsystem, and/or a Bluetooth™ subsystem. The one or more transceivers may include processors, controllers, radios, sockets, plugs, buffers, or the like circuits to form one or more communication channels to one or more radio frequency units.

The processor 710 may be of any type suitable to the local technical network and may include one or more of the following: general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

The memory 720 may include one or more non-volatile memories and one or more volatile memories. Examples of the non-volatile memories include, but are not limited to, a Read Only Memory (ROM) 724, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 722 and other volatile memories that will not last in the power-down duration.

A computer program 730 includes computer executable instructions that are executed by the associated processor 710. The instructions of the program 730 may include instructions for performing operations/acts of some example embodiments of the present disclosure. The program 730 may be stored in the memory, e.g., the ROM 724. The processor 710 may perform any suitable actions and processing by loading the program 730 into the RAM 722.

The example embodiments of the present disclosure may be implemented by means of the program 730 so that the device 700 may perform any process of the disclosure as discussed with reference to FIG. 3 to FIG. 6. The example embodiments of the present disclosure may also be implemented by hardware or by a combination of software and hardware.

In some example embodiments, the program 730 may be tangibly contained in a computer readable medium which may be included in the device 700 (such as in the memory 720) or other storage devices that are accessible by the device 700. The device 700 may load the program 730 from the computer readable medium to the RAM 722 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

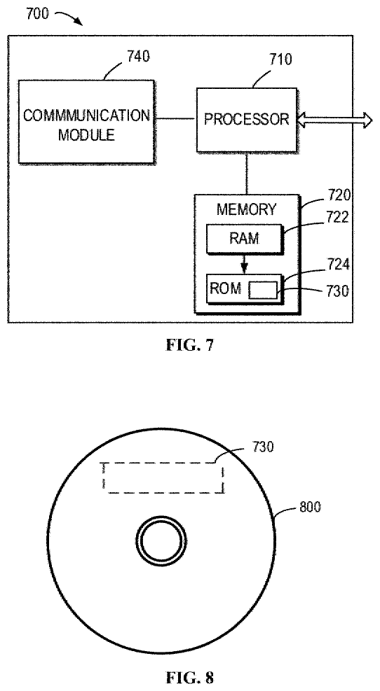

FIG. 8 shows an example of the computer readable medium 800 which may be in form of CD, DVD or other optical storage disk. The computer readable medium 800 has the program 730 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A first apparatus comprising:
one or more processors; and
one or more transceivers coupled to the one or more processors, wherein the one or more transceivers are configured with the one or more processors to cause the first apparatus to:
obtain paging subgrouping assistance information of a second apparatus, wherein the paging subgrouping assistance information comprises at least one of: a battery lifetime requirement, service information, or a device type; and
determine a paging subgroup identity for the second apparatus based on the paging subgrouping assistance information.

2. The first apparatus according to claim 1, wherein the first apparatus is further configured to:
assign the paging subgroup identity to the second apparatus.

3. The first apparatus according to claim 1- or 2, wherein the paging subgrouping assistance information further comprises at least one of the following:
a device identity,
a minimum paging interval,
a recommended subgroup,
a subgrouping request, or
a paging probability.

4. The first apparatus according to claim 1, wherein the service information indicates at least one of the following: a positioning service level, a positioning interval, grouping information of the second apparatus for a service, or a positioning reference signal configuration update interval, and
wherein the device type indicates whether the second apparatus is a low-power high-accuracy positioning (LPHAP) device.

5. The first apparatus according to claim 1, wherein the first apparatus is further configured to obtain the paging subgrouping assistance information by:
receiving the paging subgrouping assistance information from the second apparatus; or
receiving the paging subgrouping assistance information from a third apparatus which manages a service of the second apparatus.

6. The first apparatus according to claim 5, wherein the second apparatus comprises an LPHAP device, and
wherein the third apparatus comprises a location management function.

7. The first apparatus according to claim 1, wherein the first apparatus is further configured to:
transmit, to a network device which is configured to page the second apparatus, at least one of the following:
the paging subgroup identity for the second apparatus, or
a minimum paging interval for the second apparatus.

8. The first apparatus according to claim 7, wherein the first apparatus is further configured to:
determine the minimum paging interval based on the paging subgrouping assistance information.

9. The first apparatus according to claim 1, wherein the first apparatus comprises an access and mobility management function.

10. A second apparatus comprising:
one or more processors; and
one or more transceivers coupled to the one or more processors, wherein the one or more transceivers are configured with the one or more processors to cause the second apparatus to:
transmit, to a first apparatus or a third apparatus which manages a service of the second apparatus, paging subgrouping assistance information of the second apparatus, wherein the paging subgrouping assistance information comprises at least one of: a battery lifetime requirement, service information, or a device type; and
receive, from the first apparatus, an assignment of a paging subgroup identity for the second apparatus.

11. The second apparatus according to claim 10, wherein the paging subgrouping assistance information further comprises at least one of the following:
a device identity,
a minimum paging interval,
a recommended subgroup,
a subgrouping request, or
a paging probability.

12. The second apparatus according to claim 10, wherein the service information indicates at least one of the following: a positioning service level, a positioning interval, grouping information of the second apparatus for a service, or a positioning reference signal configuration update interval, and
wherein the device type indicates whether the second apparatus is a low-power high-accuracy positioning (LPHAP) device.

13. The second apparatus according to claim 10, wherein the first apparatus comprises an access and mobility management function,
wherein the second apparatus comprises an LPHAP device, and
wherein the third apparatus comprises a location management function.

14. The second apparatus according to claim 10, wherein the second apparatus is further caused to:
transmit, to the third apparatus, capability information of the second apparatus, wherein the capability information indicates support of network-controlled subgrouping.

15. (canceled)

16. A method comprising:
transmitting, by a second apparatus and to a first apparatus or a third apparatus which manages a service of the second apparatus, paging subgrouping assistance information of the second apparatus, wherein the paging subgrouping assistance information comprises at least one of: a battery lifetime requirement, service information, or a device type; and
receiving, by the second apparatus and from the first apparatus, an assignment of a paging subgroup identity for the second apparatus.

17.-19. (canceled)

20. The method according to claim 16, wherein the paging subgrouping assistance information further comprises at least one of the following:
a device identity,
a minimum paging interval,
a recommended subgroup,
a subgrouping request, or
a paging probability.

21. The method according to claim 16, wherein the service information indicates at least one of the following: a positioning service level, a positioning interval, grouping information of the second apparatus for a service, or a positioning reference signal configuration update interval, and
wherein the device type indicates whether the second apparatus is a low-power high-accuracy positioning (LPHAP) device.

22. The method according to claim 16, wherein the first apparatus comprises an access and mobility management function,
wherein the second apparatus comprises an LPHAP device, and
wherein the third apparatus comprises a location management function.

23. The method according to claim 16, further comprising
transmitting, to the third apparatus, capability information of the second apparatus, wherein the capability information indicates support of network-controlled subgrouping.
